(19) United States
(12) Patent Application Publication
(10) Pub. No.: US 2007/0289056 A1
(43) Pub. Date: Dec. 20, 2007

(54) Apparatus and method for jet aeration

(76) Inventor: Arturo Reynoso, Azusa, CA (US)

Correspondence Address: MICHAEL BEST & FRIEDRICH LLP, 100 E WISCONSIN AVENUE, Suite 3300, MILWAUKEE, WI, 53202, US

(21) Appl. No.: 11/454,185

(22) Filed: Jun. 15, 2006

(51) Int. Cl. A61H 33/04

(52) U.S. Cl. 4/541.6

(57) ABSTRACT

Jet aerator apparatus and method. The apparatus can include a jet body including a passageway, water conduits, and an air conduit. The jet aerator can include an exit nozzle received in the passageway. The exit nozzle can include lock clips, locking tabs, and stabilizing tabs. The jet aerator can include a jet head coupled to the exit nozzle by the lock clips. The jet head can include a locking rib. The jet aerator can include a jet cover coupled to the exit nozzle. The jet cover can include slots to receive the locking tabs, stepped portions to receive the stabilizing tabs, and lock grooves to receive the locking rib.

### BACKGROUND OF THE INVENTION

In the hot tub and spa market, various types of jets are known for introducing a jet or spray of water and air into the interior of the tub. Conventional jets include those having an apertured ball or sphere, known as an “eyeball,” that can be adjusted by the user to spray water and air in a desired direction. Other conventional jets include a rotor body having sub-nozzles that spray several water/air jets into the tub. The rotor body rotates about an axis to provide a multi-stream water/air jet pattern that swirls about the axis of the rotor. Conventional flow adjustable jets with a hidden escutcheon or head generally do not allow for variability in tub wall thickness. Rather, only jets with exposed escutcheons or heads accommodate different tub wall thicknesses.

### SUMMARY OF THE INVENTION

Some embodiments of the invention provide a jet aerator for installation in a tub wall. The jet aerator can include a jet body with a passageway, a water conduit, and an air conduit. The jet aerator can include an exit nozzle received in the passageway. The exit nozzle can include one or more lock clips, one or more locking tabs, and one or more stabilizing tabs. The jet aerator can include a jet head coupled to the exit nozzle by the lock clips. The jet head can include a locking rib. The jet aerator can include ajet cover coupled to the exit nozzle. The jet cover can include one or more slots to receive the locking tabs, one or more stepped portions to receive the stabilizing tabs, and one ore more lock grooves to receive the locking rib. The jet cover and the exit nozzle can be rotatable with respect to the jet body and the jet head.

Embodiments of the invention can include a method of operating a jet aerator. The method can include rotating a jet cover and engaging one or more stabilizing tabs of an exit nozzle with one or more stepped portions of the jet cover. The method can also include rotating the exit nozzle and selectively aligning an aperture of the exit nozzle with a water conduit and/or an air conduit of a jet body.

### BRIEF DESCRIPTION OF THE DRAWINGS

FIG. 1 is an exploded perspective view of a jet aerator according to one embodiment of the invention.

FIG. 2 is a perspective view of a jet body of the jet aerator of FIG. 1.

FIG. 3 is a cross-sectional perspective view of the assembled jet aerator of FIG. 1.

FIG. 4 is an exploded perspective view of a nozzle and jet cover assembly of the jet aerator of FIG. 1.

FIG. 5 is cross-sectional front perspective view of the assembled nozzle and jet cover assembly of FIG. 4.

FIG. 6 is a back perspective view of the assembled nozzle and jet cover assembly of FIGS. 4 and 5.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

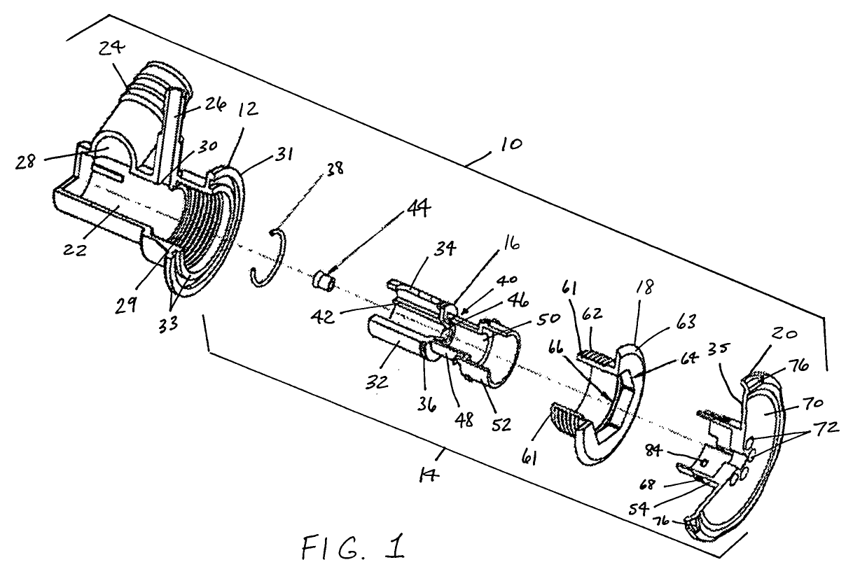

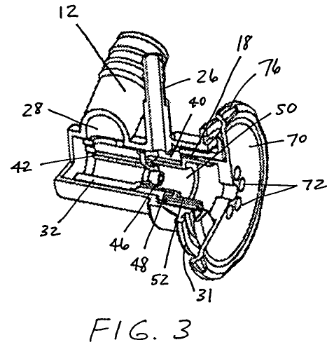

FIGS. 1 and 3 illustrate a jet aerator 10 according to one embodiment of the invention for installation in a tub wall (not shown). The jet aerator 10 can be used with a bath tub, a full-size spa, a foot spa, or a pedicure tub. The jet aerator 10 can include a jet body 12 and a nozzle and jet cover assembly 14. The nozzle and jet cover assembly 14 can include an exit nozzle 16, ajet head 18, and ajet cover 20.

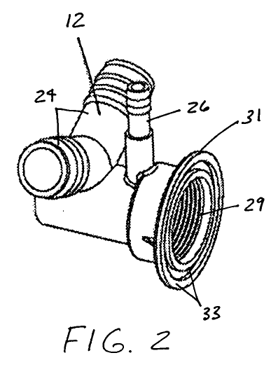

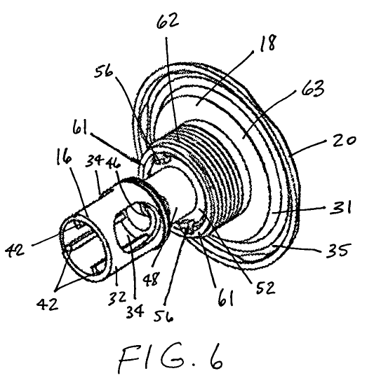

FIGS. 1-3 illustrate the jet body 12, which can be a molded unitary housing defining an elongated passageway 22 for receiving the nozzle and jet cover assembly 14. The jet body 12 can include the passageway 22, one or more water conduits 24 (e.g., for hot and cold water), and an air conduit 26. In some embodiments, the water conduits 24 and the air conduit 26 can be disposed in stacked relation on one side of the passageway 22 in order to conserve space. The passageway 22 can extend to a front portion of the jet body 12. The water conduits 24 can include one or more water opening 28 into the passageway 22, and the air conduit 26 can include an air opening 30 into the passageway 22. The jet body 12 can include a threaded inner diameter portion 29 that can receive and secure the jet head 18. The jet body 12 can also include a flange 31 with one or more outward-facing annular walls 33. The flange 31 can be positioned between a tub wall (not shown) and the jet head 18 and a back side 35 of the jet cover 20, as shown in FIGS. 1 and 6.

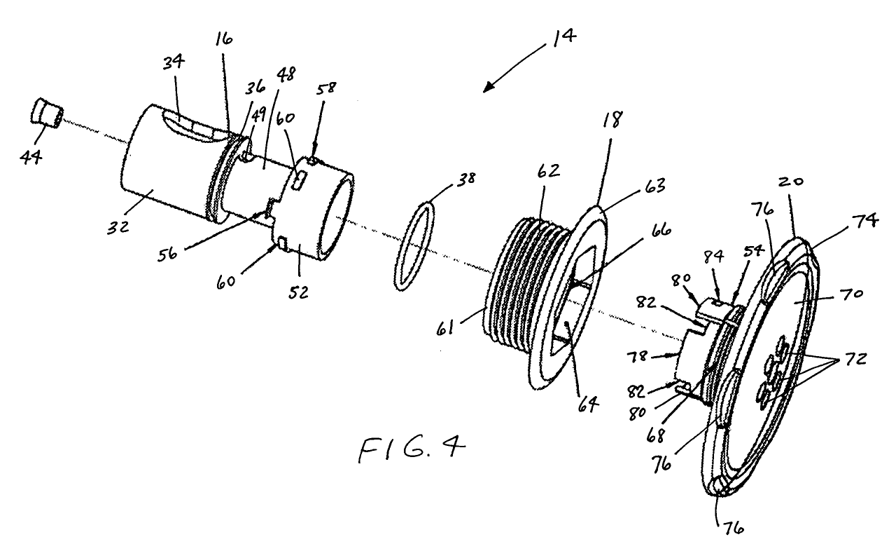

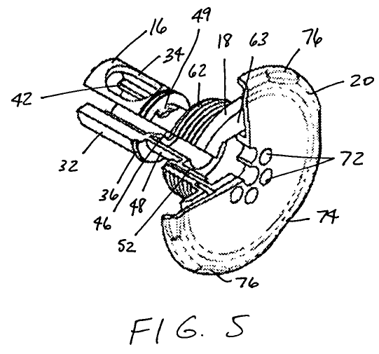

The exit nozzle 16 can be positioned in the passageway 22 of the jet body 12. The water openings 28 and the air opening 30 can communicate with the passageway 22 and the exit nozzle 16. The exit nozzle 16 can include a first portion 32 with one or more apertures 34 that can be selectively aligned with the water openings 28 and the air opening 30 in order to adjust the amount of water and air in the passageway 22. The first portion 32 can also include a seat 36 that can receive a seal 38 in order to define an aerating chamber 40 (as shown in FIG. 3) around a second portion 48 of the exit nozzle 16. In some embodiments, the exit nozzle 16 can be generally cylindrical and the seal 38 can be a flexible cylindrical seal, such as an O-ring. The exit nozzle 16 can include one or more longitudinally-extending interior walls 42. The exit nozzle 16 can include a flow reducer cylinder 44, which can be replaceable, in some embodiments. The exit nozzle 16 can include a metering orifice 46 positioned in a downstream end wall of the first portion 32. The metering orifice 46 can allow water to enter the second portion 48 of the exit nozzle 16. The second portion 48 of the exit nozzle 16 can have a reduced diameter from the first portion 32. The second portion 48 can include an aperture 49 (as shown in FIGS. 4 and 5) that can allow air to enter from the aerating chamber 40 into the interior of the second portion 48, where the air can mix with the water entering through the metering orifice 46. The second portion 48 can include a second orifice 50 positioned in a downstream end wall of the second portion 48. The second orifice 50 can allow mixed water and air to enter a third portion 52 of the exit nozzle 16. The third portion 52 can have an increased diameter from the second portion 48, such as approximately the same diameter as the first portion 32. The third portion 52 of the exit nozzle 16 can be sized to be received by a cylinder 54 of the jet cover 20. As shown in FIG. 4, the third portion 52 of the exit nozzle 16 can include one or more lock clips 56, one or more locking tabs 58, and/or one or more stabilizing tabs 60, each of which can engage portions of the jet head 18 and the jet cover 20. The jet head 18 can be coupled to the exit nozzle 16 by the lock clips 56. In some embodiments, the exit nozzle 16 can include two lock clips 56 positioned on opposite sides of the exit nozzle 16.

As shown in FIGS. 1 and 4, the jet head 18 can include a threaded outer diameter portion 62 that can receive the threaded inner diameter portion 29 of the jet body 12. As shown in FIG. 6, the lock clips 56 of the exit nozzle 16 can engage an end 61 of the threaded outer diameter portion 62 of the jet head 18. Referring to FIG. 1, a tub wall can be positioned between a back side of a flange 63 of the jet head 18 and the annular walls 31 of the jet body 12. In some embodiments, the flange 63 can have an edge with a bezel. The jet head 18 can be secured to the jet body 12 so that the jet head 18 remains stationary while the exit nozzle 16 and the jet cover 20 can be manually rotated to adjust the flow of water and air. In some embodiments, the exit nozzle 16 and the jet cover 20 are also removable from the jet body 12 (e.g., for cleaning or replacement). In some embodiments, the jet head 18 an include a hexagonal inner diameter portion 64 that can be rotated with a spanner wrench in order to disengage the jet head 18 from the jet body 12. The jet head 18 can also include a locking rib 66 that can engage one or more lock grooves 68 on a cylinder 54 of the jet cover 20. In some embodiments, the cylinder 54 can include three annular lock grooves 68, any one of which can receive the locking rib 66 to provide an appropriate distance between jet head 18 and the jet cover 20.

The jet cover 20 can include a face plate 70 coupled to the cylinder 54. Various types of jet covers 20 can be coupled to the jet body 12, such as eyeball configurations, rotary configurations, multi-port configurations, etc. In some embodiments, the face plate 70 can include one or more discharge apertures 72. The face plate 70 can include an edge 74 with one or more bevels. The edge 74 can include indentations 76 that can be gripped by a user to manually rotate the jet cover 20. As shown in FIG. 4, in some embodiments, the cylinder 54 of the jet cover 20 can include one or more larger sections 78 and one or more smaller sections 80. The larger sections 78 can include one or more stepped portions 82 that can receive the stabilizing tabs 60. In some embodiments, each larger section 78 can include a stepped portion 82 on each corner for a total of four stepped portions 82, and the exit nozzle 82 can include a corresponding four stabilizing tabs 60. The two smaller sections 80 can include one or more slots 84 that can receive the locking tabs 58 of the exit nozzle 16 to form a snap-on jet cover assembly. In some embodiments, the slots 84 can be rectangular and each smaller section 80 can include one slot 84.

The jet cover 20 can be coupled to the jet body 12 by inserting the cylinder 54 of the jet cover 20 into the jet head 18 and lining up the locking tabs 58 with the slots 84 in the smaller sections 80 of the cylinder 54. The jet cover 20 can be pressed toward the exit nozzle 16 until the smaller sections 80 expand over the locking tabs 58 and the locking tabs 58 snap into place within the slots 84. The stabilizing tabs 60 will then slide into the stepped portions 82 of the larger sections 78 of the cylinder 54. Once the jet cover 20 is inserted and snapped over the exit nozzle 16, the locking rib 66 of the jet head 18 can snap into one of the locking grooves 68 of the cylinder 54. In some embodiments, the locking grooves 68 extend around the perimeter of the cylinder 54 by being included in the larger sections 78 and the smaller sections 80 of the cylinder 54. The locking rib 66/locking grooves 68 and the locking clips 56 of the exit nozzle 16 can be substantially independent to provide a dual-locking system between the exit nozzle 16, the jet head 18, and the jet cover 20. The larger sections 78 and the smaller sections 80 can be compressed as the cylinder 54 is inserted into the inner diameter of the jet head 18 and can then expand outward when the locking rib 66 of the jet head 18 snaps into place in one of the locking grooves 68 of the jet cover 20. The locking clips 56 can then expand outward at the end 61 of the threaded outer diameter portion 62 of the jet head 18.

Once installed, the jet cover 20 can be manually adjusted by a user. As the user rotates the jet cover 20, the locking rib 66 of the jet head 18 freely rotates within one of the lock grooves 68 of the cylinder 54. As a result, the jet head 18 does not rotate, but remains stationary with respect to the jet body 12 and the tub wall. However, the stepped portions 82 of the jet cover 20 engage the stabilizing tabs 60 of the exit nozzle 16 so that the exit nozzle 16 rotates with the jet cover 20. As the jet cover 20 and the exit nozzle 16 rotate, the apertures 34 of the exit nozzle 16 can be selectively aligned with respect to the water conduits 28 and the air conduit 26 of the jet body 12 in order to adjust the amount of water and air in the passageway 22.

Various additional features and advantages of the invention are set forth in the following claims.

1. A jet aerator for installation in a tub wall, the jet aerator comprising:
a jet body including a passageway, at least one water conduit, and an air conduit;
an exit nozzle received in the passageway, the exit nozzle including at least one lock clip, at least one locking tab, and at least one stabilizing tab;
a jet head coupled to the exit nozzle by the at least one lock clip, the jet head including a locking rib; and
a jet cover coupled to the exit nozzle, the jet cover including at least one slot to receive the at least one locking tab, at least one stepped portion to receive the at least one stabilizing tab, and at least one lock groove to receive the locking rib, the jet cover and the exit nozzle rotatable with respect to the jet body and the jet head.

2. The jet aerator of claim 1 wherein the exit nozzle includes an aperture that can be selectively aligned with the at least one water conduit and the air conduit in order to adjust amounts of water and air in the passageway.

3. The jet aerator of claim 1 and further comprising a seal positioned between the exit nozzle and the jet body to define an aerating chamber.

4. The jet aerator of claim 1 and further comprising a flow reducer cylinder positioned in the exit nozzle, and wherein the flow reducer cylinder is replaceable.

5. The jet aerator of claim 1 wherein the jet aerator is coupled to one of a bath tub, a full-size spa, a foot spa, and a pedicure tub.

6. The jet aerator of claim 1 wherein the at least one lock clip engages an end of the jet head.

7. The jet aerator of claim 1 wherein two locking tabs are received by two rectangular slots.

8. The jet aerator of claim 1 wherein the jet cover includes a cylinder with two larger sections and two smaller sections, wherein each one of the two larger sections includes two stepped portions that receive two stabilizing tabs, and wherein each one of the two smaller sections includes one slot.

9. The jet aerator of claim 1 wherein the exit nozzle and the jet cover are removable from the jet body, with the jet body remaining coupled to the tub wall.

10. The jet aerator of claim 1 wherein the at least one water conduit and the air conduit are disposed in stacked relation on one side of the passageway.

11. The jet aerator of claim 1 wherein the jet cover and the exit nozzle are manually adjustable with respect to the jet body and the jet head to control amounts of water and air in the passageway.

12. The jet aerator of claim 1 wherein the exit nozzle is cylindrical.

13. The jet aerator of claim 1 wherein the exit nozzle includes a seat that receives a cylindrical seal.

14. The jet aerator of claim 1 wherein at least a portion of an inner diameter of the jet head is hexagonal.

15. The jet aerator of claim 1 wherein the jet cover is rotated by a user, wherein the at least one stepped portion engages the at least one stabilizing tab to rotate the exit nozzle, and wherein an aperture of the exit nozzle selectively aligns with respect to the at least one water conduit and the air conduit in response to rotation of the jet cover.

16. A nozzle and jet cover assembly for use with a jet body installed in a tub wall, the jet body including a passageway, at least one water conduit, and an air conduit, the nozzle and jet cover assembly comprising:
an exit nozzle received in the passageway, the exit nozzle including at least one lock clip, at least one locking tab, and at least one stabilizing tab;
a jet head coupled to the exit nozzle by the at least one lock clip, the jet head including a locking rib; and
a jet cover coupled to the exit nozzle, the jet cover including at least one slot to receive the at least one locking tab, at least one stepped portion to receive the at least one stabilizing tab, and at least one lock groove to receive the locking rib, the jet cover and the exit nozzle rotatable with respect to the jet body and the jet head.

17. The nozzle and jet cover assembly of claim 16 wherein the exit nozzle includes an aperture that can be selectively aligned with the at least one water conduit and the air conduit in order to adjust amounts of water and air in the passageway.

18. The nozzle and jet cover assembly of claim 16 and further comprising a seal positioned between the exit nozzle and the jet body to define an aerating chamber.

19. The nozzle and jet cover assembly of claim 16 and further comprising a flow reducer cylinder positioned in the exit nozzle, and wherein the flow reducer cylinder is replaceable.

20. The nozzle and jet cover assembly of claim 16 wherein the jet body is coupled to one of a bath tub, a full-size spa, a foot spa, and a pedicure tub.

21. The nozzle and jet cover assembly of claim 16 wherein the at least one lock clip engages an end of the jet head.

22. The nozzle and jet cover assembly of claim 16 wherein two locking tabs are received by two rectangular slots.

23. The nozzle and jet cover assembly of claim 16 wherein the jet cover includes a cylinder with two larger sections and two smaller sections, wherein each one of the two larger sections includes two stepped portions that receive two stabilizing tabs, and wherein each one of the two smaller sections includes one slot.

24. The nozzle and jet cover assembly of claim 16 wherein the exit nozzle and the jet cover are removable from the jet body, with the jet body remaining coupled to the tub wall.

25. The nozzle and jet cover assembly of claim 16 wherein the at least one water conduit and the air conduit are disposed in stacked relation on one side of the passageway.

26. The nozzle and jet cover assembly of claim 16 wherein the jet cover and the exit nozzle are manually adjustable with respect to the jet body and the jet head to control amounts of water and air in the passageway.

27. The nozzle and jet cover assembly of claim 16 wherein the exit nozzle is cylindrical.

28. The nozzle and jet cover assembly of claim 16 wherein the exit nozzle includes a seat that receives a cylindrical seal.

29. The nozzle and jet cover assembly of claim 16 wherein at least a portion of an inner diameter of the jet head is hexagonal.

30. The nozzle and jet cover assembly of claim 16 wherein the jet cover is rotated by a user, wherein the at least one stepped portion engages the at least one stabilizing tab to rotate the exit nozzle, and wherein an aperture of the exit nozzle selectively aligns with respect to the at least one water conduit and the air conduit in response to rotation of the jet cover.

31. A method of operating a jet aerator, the method comprising:
rotating a jet cover;
engaging at least one stabilizing tab of an exit nozzle with at least one stepped portion of the jet cover;
rotating the exit nozzle; and
selectively aligning an aperture of the exit nozzle with at least one water conduit and an air conduit of a jet body.

32. The method of claim 31 and further comprising installing the jet body in a tub wall and positioning the exit nozzle in a passageway of the jet body.

33. The method of claim 31 and further comprising coupling a jet head to the exit nozzle by at least one lock clip of the exit nozzle.

34. The method of claim 31 and further comprising receiving at least one locking tab of the exit nozzle in at least one slot of the jet cover.

35. The method of claim 31 and further comprising receiving a locking rib of a jet head within at least one lock groove of the jet cover.

36. The method of claim 31 and further comprising rotating the jet cover and the exit nozzle with respect to the jet body and a jet head.

37. The method of claim 31 and further comprising selectively aligning the aperture of the exit nozzle with the at least one water conduit and the air conduit of the jet body in order to adjust amounts of water and air in a passageway of the jet body.

38. The method of claim 31 and further comprising positioning a seal between the exit nozzle and the jet body to define an aerating chamber.

39. The method of claim 31 and further comprising positioning a replaceable flow reducer cylinder in the exit nozzle.

40. The method of claim 31 and further comprising coupling the jet body to one of a bath tub, a full-size spa, a foot spa, and a pedicure tub.

41. The method of claim 31 and further comprising engaging an end of a jet head with at least one lock clip of the exit nozzle.

42. The method of claim 31 and further comprising receiving two locking tabs of the exit nozzle within two rectangular slots of the jet cover.

43. The method of claim 31 and further comprising removing the exit nozzle and the jet cover from the jet body, with the jet body remaining coupled to the tub wall.

44. The method of claim 31 and further comprising rotating a hexagonal inner diameter of the jet head with a spanner wrench.
